(19) United States
(12) Patent Application Publication
(10) Pub. No.: US 2026/0169591 A1
(43) Pub. Date: Jun. 18, 2026

(54) TOUCH SENSING DISPLAY APPARATUS AND CLAMPING VOLTAGE CONTROL METHOD THEREOF

(71) Applicant: LG Display Co., Ltd., Seoul (KR)

(72) Inventor: Yeon Wook KANG, Paju-si (KR)

(73) Assignee: LG Display Co., Ltd., Seoul (KR)

(21) Appl. No.: 19/375,987

(22) Filed: Oct. 31, 2025

(30) Foreign Application Priority Data
Dec. 17, 2024 (KR) 10-2024-0188862

(51) Int. Cl. G06F 3/041; G06F 3/044

(52) U.S. Cl. CPC G06F 3/04184; G06F 3/0412; G06F 3/04164; G06F 3/04166; G06F 3/044

(57) ABSTRACT

A touch sensing display apparatus includes a clamp circuit including a first diode between an input pad and a first terminal receiving a positive clamping voltage and a second diode between the input pad and a second terminal receiving a negative clamping voltage, an ESD detection circuit connected between a cathode of the first diode and the first terminal and between a cathode of the second diode and the input pad to detect whether ESD is included in an AC common signal input through the input pad, and a clamp voltage variation circuit configured to, when the ESD is not detected, vary a difference between the positive and negative clamping voltages to a first range so that the AC common signal is not clamped, and when the ESD is detected, vary the difference to a second range, so that a portion of the AC common signal is clamped.

### CROSS-REFERENCE TO RELATED APPLICATIONS

This application claims the benefit of and priority to Korean Patent Application No. 10-2024-0188862, filed on December 17, 2024, the entire contents of which are incorporated herein by reference for all purposes.

### BACKGROUND

### 1. Technical Field

The present disclosure relates to a touch sensing display apparatus and a clamping voltage control method thereof.

### 2. Description of Related Art

In-cell touch sensor technology where touch sensors are embedded in a pixel array of a display panel has been known. To reduce electromagnetic interference (EMI) noise, an electrostatic discharge (ESD) protection circuit has been provided in an input/output (I/O) pad of a touch display driver integrated circuit (IC) (TDDI). The ESD protection circuit clamps an output waveform by using a diode-based clamping circuit, and thus, protects a display apparatus from ESD.

When touch sensing display apparatuses of in-cell type are based on a liquid crystal display (LCD) apparatus, a common voltage ripple may increase in proportion to a swing width of a source output for inversion driving. The common voltage ripple is an alternating current (AC) frequency component and acts as EMI noise. To decrease the common voltage ripple, a common voltage compensation signal having a phase opposite thereto should be applied to a display panel. However, a compensation voltage, which is higher than a clamping voltage, in the common voltage compensation signal may be clamped and cut off by a clamp circuit included in the I/O pad of the TDDI, and thus, a common voltage ripple may not be sufficiently compensated for. Because a clamping voltage of the clamp circuit is fixed to a high voltage and a low voltage which are predetermined, a region of a high voltage or more and a region of a low voltage or less in the common voltage compensation signal are output while being unconditionally cut off regardless of an ESD input.

The description of related art should not be considered prior art merely because it is mentioned in or associated with this section. The description of related art includes information that describes one or more aspects of the subject technology, and the description in this section does not limit the scope of the invention.

### SUMMARY

To overcome the aforementioned problem of the related art, one or more aspects of the present disclosure may provide a touch sensing display apparatus and a clamping voltage control method thereof, which may differently vary a clamping voltage, based on whether ESD is detected, and may prevent a common voltage compensation signal from being unconditionally clamped regardless of an ESD input.

To achieve these aspects and other advantages and in accordance with the purpose of the disclosure, as embodied and broadly described herein, a touch sensing display apparatus includes: a clamp circuit including a first diode connected between an input pad and a first voltage terminal receiving a positive clamping voltage and a second diode connected between the input pad and a second voltage terminal receiving a negative clamping voltage; an electrostatic discharge (ESD) detection circuit connected between a cathode electrode of the first diode and the first voltage terminal and between a cathode electrode of the second diode and the input pad to detect whether ESD is included in an alternating current (AC) common signal input through the input pad; and a clamp voltage variation circuit configured to, when the ESD is not detected, vary a difference between the positive clamping voltage and the negative clamping voltage to a first voltage range so that the AC common signal is not clamped in the clamp circuit, and when the ESD is detected, vary the difference between the positive clamping voltage and the negative clamping voltage to a second voltage range which is narrower than the first voltage range, so that a portion of the AC common signal is clamped in the clamp circuit.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further features, advantages, and aspects are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure. In the drawings:

FIG. 1 is a diagram illustrating a touch sensing display apparatus according to an embodiment of the present disclosure;

FIG. 2 is a diagram illustrating an embodiment of a touch sensor embedded in a pixel array;

FIG. 3 is a diagram illustrating an example where display driving and touch driving are temporally divided;

FIG. 4 is a diagram illustrating a connection relationship between a display panel, a touch display driver integrated circuit (IC) (TDDI), and a common voltage compensation circuit;

FIG. 5 is a diagram illustrating a configuration of an electrostatic discharge (ESD) protection circuit which differently varies a clamping voltage, based on whether ESD is detected;

FIG. 6 is a diagram illustrating a detailed connection configuration of a clamp circuit, an ESD detection circuit, and a clamp voltage variation circuit;

FIG. 7 is a diagram illustrating an example where a positive/negative clamping voltage is shifted to a first voltage range, based on non-ESD detection, and a positive/negative clamping voltage is shifted to a second voltage range, based on ESD detection;

FIG. 8 is a diagram illustrating a detailed configuration of an ESD detection circuit;

FIG. 9 is a diagram illustrating whether aperiodic ESD of a touch driving signal is detected during a touch driving period and a subsequent execution operation;

FIG. 10 is a diagram illustrating whether overcurrent ESD of a compensation common voltage is detected during a display driving period and a subsequent execution operation; and

FIG. 11 is a diagram illustrating an example where cases of FIGS. 9 and 10 are combined.

### DETAILED DESCRIPTION

Hereinafter, the present disclosure will be described more fully with reference to the accompanying drawings, in which exemplary embodiments of the disclosure are shown. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art.

Advantages and features of the present disclosure, and implementation methods thereof will be clarified through following embodiments described with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. Furthermore, the present disclosure is only defined by scopes of claims.

The shapes, sizes, ratios, angles, numbers and the like disclosed in the drawings for description of various embodiments of the present disclosure to describe embodiments of the present disclosure are merely exemplary and the present disclosure is not limited thereto. Like reference numerals refer to like elements throughout. Throughout this specification, the same elements are denoted by the same reference numerals. As used herein, the terms “comprise”, “having”, “including” and the like suggest that other parts can be added unless the term “only” is used. As used herein, the singular forms “a”, “an”, and “the” are intended to include the plural forms as well, unless context clearly indicates otherwise. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

Elements in various embodiments of the present disclosure are to be interpreted as including margins of error even without explicit statements.

In describing a position relationship, for example, when a position relation between two parts is described as “on~”, “over~”, “under~”, and “next~”, one or more other parts may be disposed between the two parts unless “just” or “direct” is used.

It will be understood that, although the terms “first”, “second”, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

In the following description, when the detailed description of the relevant known function or configuration is determined to unnecessarily obscure the important point of the present disclosure, the detailed description will be omitted. Hereinafter, embodiments of the present disclosure will be described in detail with reference to the accompanying drawings.

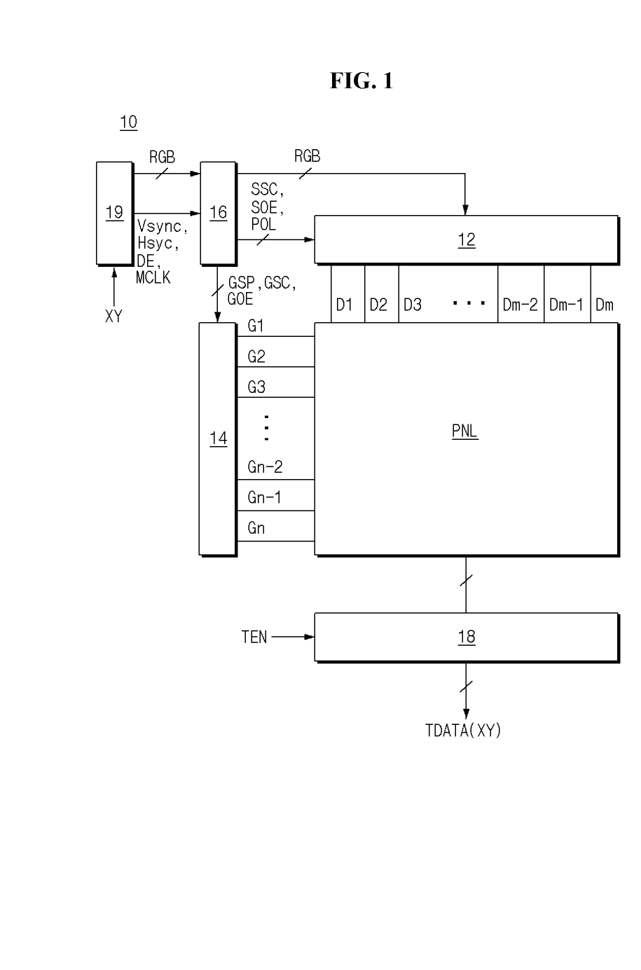

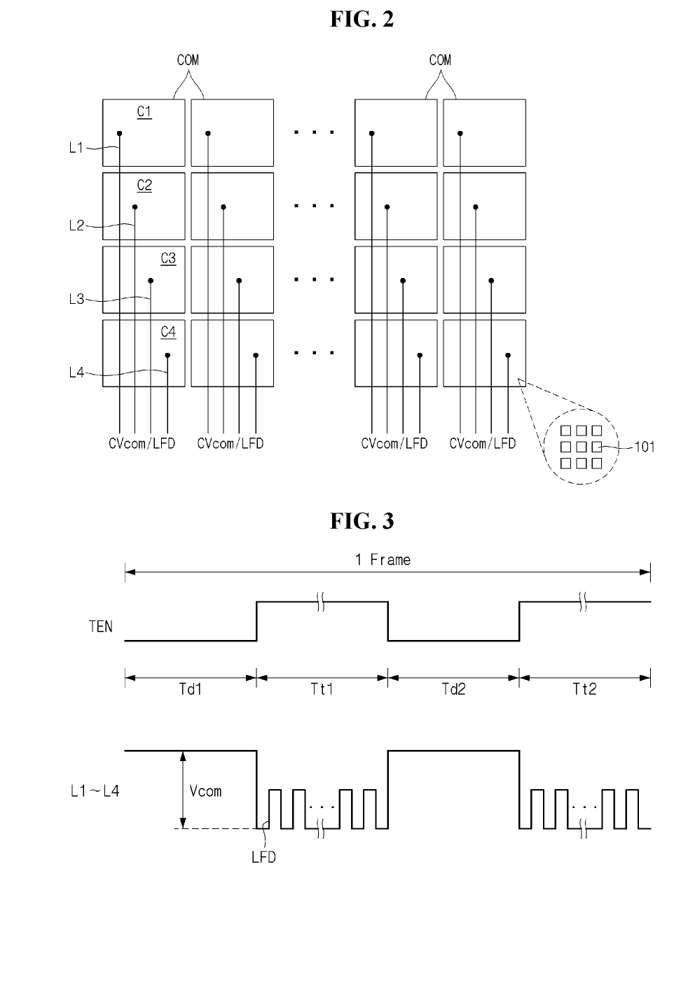

FIG. 1 is a diagram illustrating a touch sensing display apparatus 10 according to an embodiment of the present disclosure. FIG. 2 is a diagram illustrating an embodiment of a touch sensor embedded in a pixel array. FIG. 3 is a diagram illustrating an example where display driving and touch driving are temporally divided.

Referring to FIGS. 1 to 3, the touch sensing display apparatus 10 according to an embodiment of the present disclosure may be implemented based on a liquid crystal display (LCD).

The touch sensing display apparatus 10 may be configured with a display module and a touch module.

The touch module may include a touch screen and a touch driving device 18.

The touch screen may be implemented as a capacitive type which senses a touch input through a plurality of capacitance sensors. The touch screen may include a plurality of touch sensors having a capacitance. A capacitance may be divided into a self-capacitance and a mutual capacitance. A self-capacitance may be formed along a single-layer conductive line which is formed in one direction, and a mutual capacitance may be formed between two conductive lines perpendicular to each other.

The touch sensors of the touch screen may be embedded in a pixel array of a display panel PNL. An example of an in-cell type where the touch screen is embedded in the pixel array of the display panel PNL is illustrated in FIG. 2. Referring to FIG. 2, the pixel array of the display panel PNL may include touch sensors C1 to C4 and sensor lines L1 to L4 connected to the touch sensors C1 to C4. A common electrode COM of pixels 101 may be divided into a plurality of segments. The touch sensors C1 to C4 may be implemented with a divided common electrode COM. One common electrode segment may be connected to a plurality of pixels 101 in common and may configure one touch sensor.

As in FIG. 3, the touch sensors C1 to C4 may supply a common voltage Vcom to the pixels 101 during a display driving period Td1 and Td2 and may receive a touch driving signal LFD to sense a touch input during a touch driving period Tt1 and Tt2. FIG. 2 illustrates a touch sensor of self-capacitive type, but the touch sensors C1 to C4 are not limited thereto.

The touch driving device 18 may drive the touch sensors during the touch driving period Tt1 and Tt2 in response to a touch enable signal TEN input from a timing controller 16 or a host system 19. The touch driving device 18 may supply the touch driving signal LFD to the touch sensors C1 to C4 through the sensor lines L1 to Li to sense a touch input during the touch driving period Tt1 and Tt2. The touch driving device 18 may sense a capacitance variation of a touch sensor before and after a touch to determine a touch input through a conductive material such as a finger (or a stylus pen) and may calculate coordinates of a touch input position. Coordinate information about the touch input position may be transferred to the host system 19.

The display module may include the display panel PNL, a display driving circuit 12, 14, and 16, and the host system 19.

The display panel PNL may include a liquid crystal layer formed between two substrates. The pixel array of the display panel PNL may include the plurality of pixels 101 which are formed in a pixel area defined by data lines D1 to Dm (where m may be a positive integer) and gate lines G1 to Gn (where n may be a positive integer).

A black matrix and a color filter may be formed in an upper substrate of the display panel PNL. A lower substrate of the display panel PNL may be implemented in a color filter on TFT (COT) structure. In this case, the black matrix and the color filter may be formed in the lower substrate of the display panel PNL. The common electrode supplied with the common voltage may be formed in the upper substrate or the lower substrate of the display panel PNL. A polarizer may be attached to each of the upper substrate and the lower substrate of the display panel PNL, and an alignment layer for setting a pretilt angle of a liquid crystal may be formed in an inner surface contacting the liquid crystal. A column spacer for maintaining a cell gap of a liquid crystal cell may be formed between the upper substrate and the lower substrate of the display panel PNL.

A backlight unit may be disposed under a rear surface of the display panel PNL. The backlight unit may be implemented as a backlight unit of edge type or direct type and may irradiate light onto the display panel PNL. The display panel PNL may be implemented in a liquid crystal mode such as a twisted nematic (TN) mode, a vertical alignment (VA) mode, an in plane switching (IPS) mode, or a fringe field switching (FFS) mode known to those skilled in the art.

The display driving circuit may include a data driving circuit 12, a gate driving circuit 14, and a timing controller 16 and may write video data of an input image in the pixels 101 of the display panel PNL. The data driving circuit 12 may convert digital video data RGB input from the timing controller 16 with an analog positive/negative gamma compensation voltage to output a data voltage. The data voltage output from the data driving circuit 12 may be supplied to the data lines D1 to Dm. The gate driving circuit 14 may sequentially supply a gate pulse (or a scan pulse), synchronized with the data voltage, to the gate lines G1 to Gn to select a pixel line of the display panel PNL in which the data voltage is written.

The timing controller 16 may receive a timing signal such as a vertical synchronization signal Vsync, a horizontal synchronization signal Hsync, a data enable signal DE, and a main clock MCLK input from the host system 19 to synchronize an operation timing of the data driving circuit 12 with an operation timing of the gate driving circuit 14. A scan timing control signal may include a gate start pulse GSP, a gate shift clock, and a gate output enable signal GOE. A data timing control signal may include a source sampling clock SSC, a polarity control signal POL, and a source output enable signal SOE.

The host system 19 may transfer the digital video data RGB and the timing signals Vsync, Hsync, DE, and MCLK to the timing controller 16 and may execute an application program associated with touch coordinate information XY input from the touch driving device 18.

During the display driving period Td1 and Td2, the data driving circuit 12 may supply a data voltage to the data lines D1 to Dm, based on control by the timing controller 16, and the gate driving circuit 14 may sequentially supply the gate pulse, synchronized with the data voltage, to the gate lines G1 to Gn, based on control by the timing controller 16. Also, during the display driving period Td1 and Td2, the touch driving device 18 may stop an operation.

During the touch driving period Tt1 and Tt2, the touch driving device 18 may apply the touch driving signal LFD to the touch sensors of the touch screen. Also, during a touch driving period Tt1 and Tt2, the display driving circuit 12, 14, and 16 may supply the signal lines D1 to Dm and G1 to Gn with an alternating current (AC) signal having the same amplitude and phase as those of the touch driving signal LFD so as to minimize a parasitic capacitance between the touch sensors and the signal lines D1 to Dm and G1 to Gn connected to the pixels. In this case, display noise occurring in a touch sensing signal may be reduced.

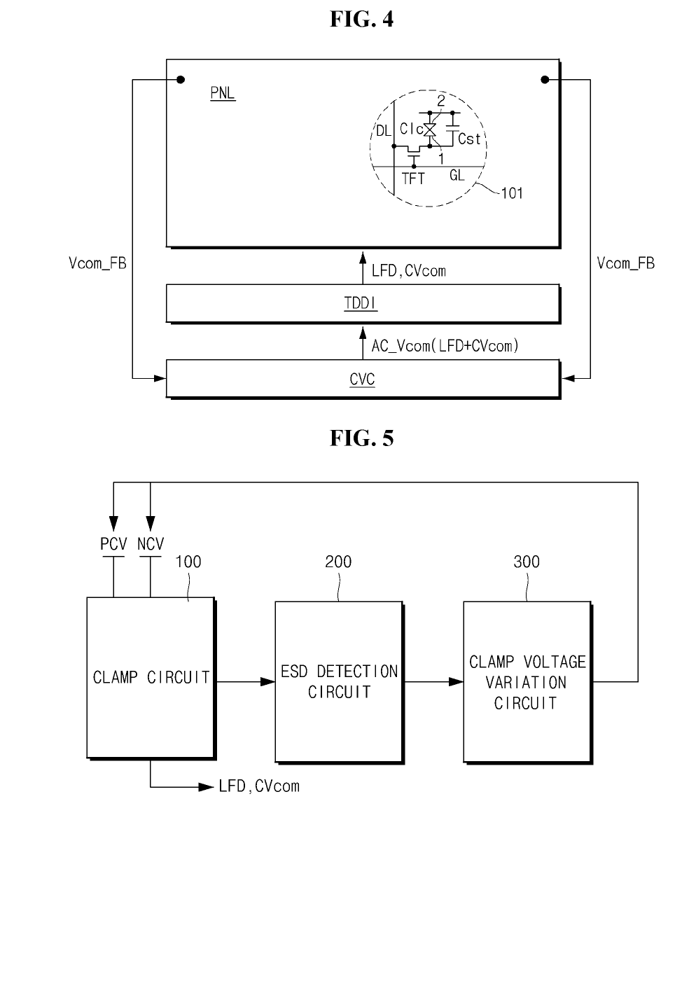

FIG. 4 is a diagram illustrating a connection relationship between a display panel, a touch display driver integrated circuit (IC) (TDDI), and a common voltage compensation circuit.

Referring to FIG. 4, each of pixels 101 of a display panel PNL may include a thin film transistor (TFT) formed in an intersection portion between a data line DL and a gate line GL, a pixel electrode 1 which is charged with a data voltage, a common electrode 2 opposite to the pixel electrode 1, a liquid crystal cell Clc which is formed between the pixel electrode 1 and the common electrode 2, and a storage capacitor Cst which is connected to the pixel electrode 1 and the common electrode 2 to hold a voltage of the liquid crystal cell Clc.

A common voltage compensation circuit CVC may be connected to the common electrode 1 of the pixels 101 through feedback lines. The common voltage compensation circuit CVC may receive a feedback common voltage Vcom_FB from the display panel PNL through the feedback line. Ripple may occur in the feedback common voltage Vcom_FB due to a variation of a source output and a variation of a touch driving signal. A common voltage ripple may increase in proportion to a swing width of the source output. The common voltage ripple may be an AC frequency component and may act as EMI noise, and thus, should be minimized. To offset the common voltage ripple, the common voltage compensation circuit CVC may generate a common voltage compensation signal CVcom having a phase opposite to ripple, and then, may output an AC common signal AC_VCOM, where the touch driving signal LFD and the common voltage compensation signal CVcom are combined, to a TDDI. The TDDI may be referred to as a touch & display drive IC.

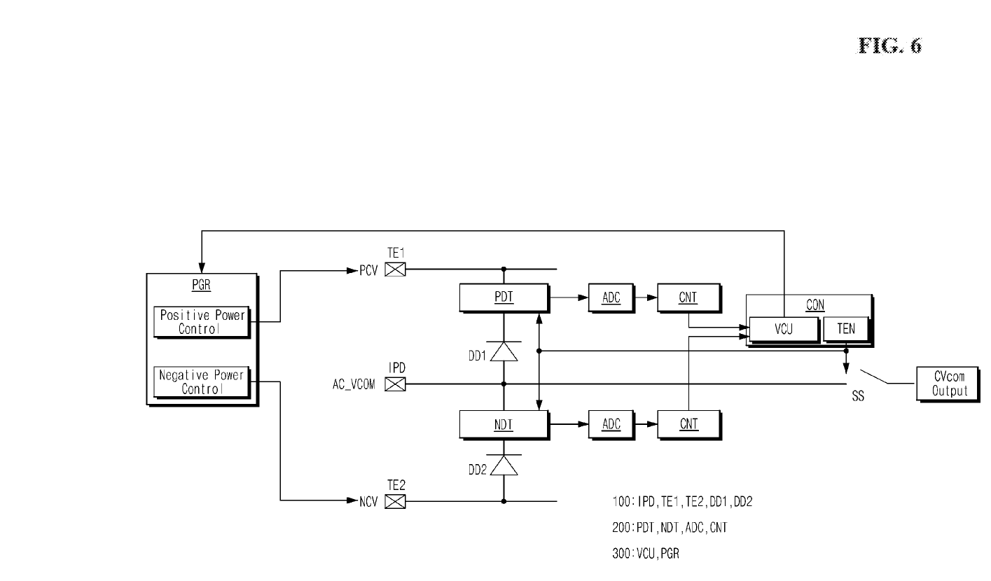

An electrostatic discharge (ESD) protection circuit (see FIG. 5) for protecting a circuit from ESD may be electrically connected to an input/output (I/O) pad of the TDDI. The ESD protection circuit may differently vary a clamping voltage, based on whether ESD is detected, and thus, may solve a conventional problem where the common voltage compensation signal CVcom is unconditionally clamped regardless of an ESD input.

When ESD is detected, the touch driving signal LFD may be clamped by the ESD protection circuit. When the touch driving signal LFD is clamped, touch sensing performance may be reduced, and thus, the TDDI may further include an LFD generating circuit therein. The touch driving signal LFD re-generated by the LFD generating circuit may be output to a touch sensor (i.e., a common electrode) during a touch driving period, and during a display driving period, the common voltage compensation signal CVcom which is an output of the ESD protection circuit may be output to the common electrode.

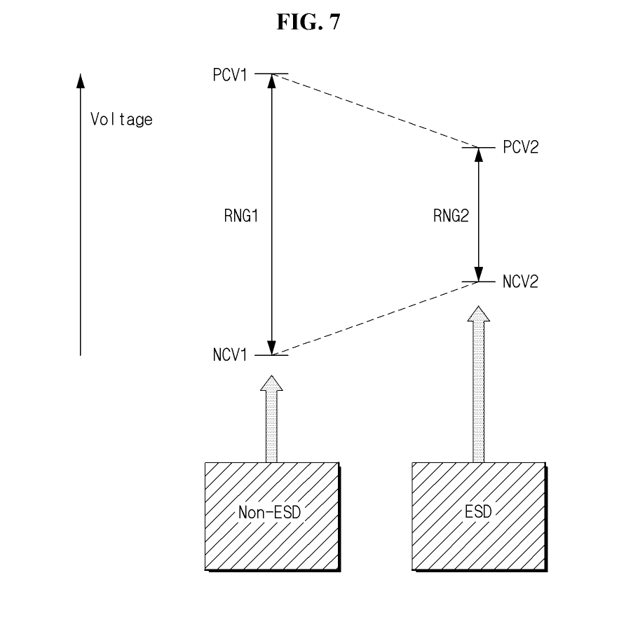

FIG. 5 is a diagram illustrating a configuration of an ESD protection circuit which differently varies a clamping voltage, based on whether ESD is detected. FIG. 6 is a diagram illustrating a detailed connection configuration of a clamp circuit, an ESD detection circuit, and a clamp voltage variation circuit. FIG. 7 is a diagram illustrating an example where a positive/negative clamping voltage is shifted to a first voltage range, based on non-ESD detection, and a positive/negative clamping voltage is shifted to a second voltage range, based on ESD detection.

Referring to FIGS. 5 and 6, the ESD protection circuit according to an embodiment of the present disclosure may include a clamp circuit 100, an ESD detection circuit 200, and a clamp voltage variation circuit 300.

The clamp circuit 100 may include a first diode DD1 connected between an input pad IPD and a first voltage terminal TE1 receiving a positive clamping voltage PCV and a second diode DD2 connected between the input pad IPD and a second voltage terminal TE2 receiving a negative clamping voltage NCV.

The ESD detection circuit 200 may be connected between a cathode electrode of the first diode DD1 and the first voltage terminal TE1 and between a cathode electrode of the second diode DD2 and the input pad IPD and may detect whether ESD occurs in an AC common signal AC_VCOM input through the input pad IPD.

The ESD detection circuit 200 may include a positive detection circuit PDT connected between the cathode electrode of the first diode DD1 and the first voltage terminal TE1 and a negative detection circuit NDT connected between the cathode electrode of the second diode DD2 and the input pad IPD. The ESD detection circuit 200 may further include an analog-to-digital converter ADC and a counter CNT connected to the positive detection circuit PDT and an analog-to-digital converter ADC and a counter CNT connected to the negative detection circuit NDT.

The positive detection circuit PDT may generate an analog positive detection signal about whether ESD is included in the AC common signal AC_VCOM. The analog positive detection signal may be an aperiodic detection signal caused by ESD or an overcurrent detection signal caused by ESD. The analog positive detection signal may be converted into digital positive detection information through the analog-to-digital converter ADC, and then, may be input to the counter CNT. The counter CNT may output positive count information about the number of ESD, based on the digital positive detection information.

The negative detection circuit NDT may generate an analog negative detection signal about whether ESD is included in the AC common signal AC_VCOM. The analog negative detection signal may be an aperiodic detection signal caused by ESD or an overcurrent detection signal caused by ESD. The analog negative detection signal may be converted into digital negative detection information through the analog-to-digital converter ADC, and then, may be input to the counter CNT. The counter CNT may output negative count information about the number of ESD, based on the digital negative detection information.

The clamp voltage variation circuit 300 may include a voltage control unit VCU of a controller CON and a power circuit PGR.

The voltage control unit VCU of the controller CON may receive the positive count information and the negative count information from the counters CNT. The voltage control unit VCU may determine whether ESD is detected or not, based on the positive count information and the negative count information.

As illustrated in FIG. 7, when ESD is not detected, the voltage control unit VCU may control the power circuit PGR to vary a difference between a positive clamping voltage PCV and a negative clamping voltage NCV to a first voltage range RNG1, and thus, may allow the clamp circuit 100 not to clamp the AC common signal AC_VCOM.

As illustrated in FIG. 7, when ESD is detected, the voltage control unit VCU may control the power circuit PGR to vary a difference between the positive clamping voltage PCV and the negative clamping voltage NCV to a second voltage range RNG2, and thus, may allow the clamp circuit 100 to clamp a portion of the AC common signal AC_VCOM.

A positive clamping voltage PCV1 defining the first voltage range RNG1 may be higher than a positive clamping voltage PCV2 defining the second voltage range RNG2. Also, a negative clamping voltage NCV1 defining the first voltage range RNG1 may be lower than a negative clamping voltage NCV2 defining the second voltage range RNG2.

A switch SS may be further provided between the input pad IPD and an output pad. In response to a touch enable signal TEN, the switch SS may be turned on in a display driving period and may be turned off in a touch driving period.

In the display driving period, when ESD is detected, a common voltage compensation signal CVcom clamped to the second voltage range RNG2 may be output to the output pad, and when ESD is not detected, a common voltage compensation signal CVcom which is not clamped to have the first voltage range RNG1 may be output to the output pad.

As described above, when a range of a clamping voltage is differently changed based on whether ESD is detected, the common voltage compensation signal CVcom may be effectively prevented from being unconditionally clamped regardless of an ESD input.

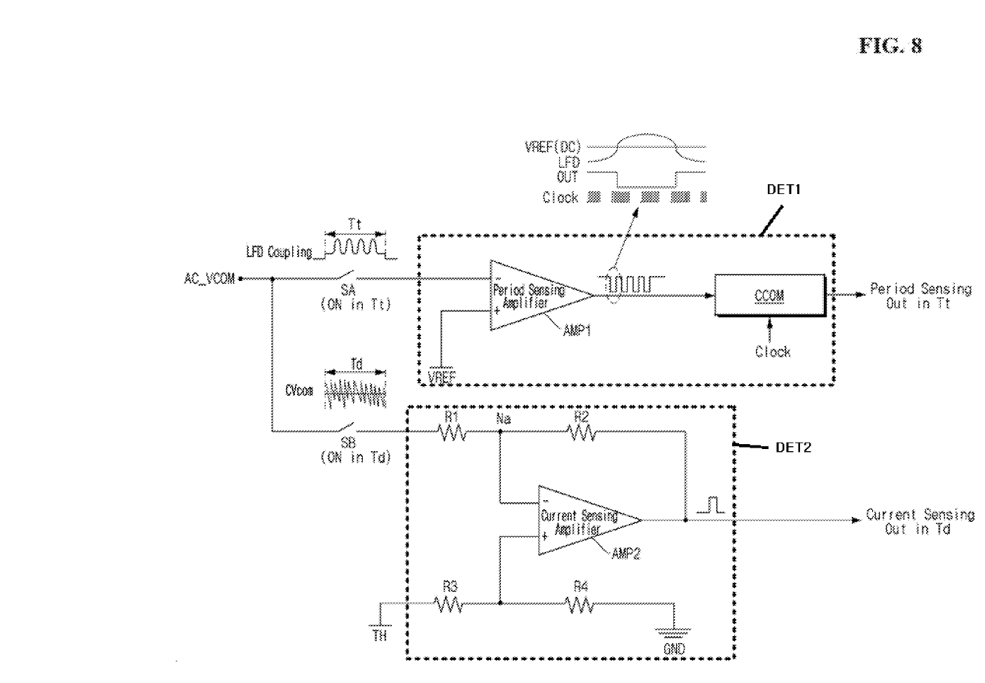

FIG. 8 is a diagram illustrating a detailed configuration of an ESD detection circuit.

Each of the positive detection circuit PDT and the negative detection circuit NDT described above may be implemented as in FIG. 8.

Each of the positive detection circuit PDT and the negative detection circuit NDT may include a first detector DET1 for generating an aperiodic detection signal and a second detector DET2 for generating an overcurrent detection signal.

The first detector DET1, as shown in FIG. 8, may include a first amplifier AMP1 which includes a (-) input terminal receiving a touch driving signal LFD of an AC common signal AC_VCOM in a touch driving period Tt, a (+) input terminal receiving a reference voltage VREF, and an output terminal. The first amplifier AMP1 may output a result obtained by sensing a period of the touch driving signal LFD.

The first detector DET1 may include a counter-type comparator CCOM which counts an output of the first amplifier AMP1 using a reference clock to obtain a count value and compares the count value with a prestored reference count value. When the count value differs from the reference count value, the counter-type comparator CCOM may detect aperiodic ESD of the touch driving signal LFD.

The second detector DET2, as in FIG. 8, may detect overcurrent ESD included in a common voltage compensation signal CVcom of the AC common signal AC_VCOM in a display driving period Td.

The second detector DET2 may include a second amplifier AMP2 which includes a (-) input terminal, a (+) input terminal, and an output terminal, a first resistor R1 which is connected between the (-) input terminal of the second amplifier AMP2 and an input of the AC common signal AC_VCOM, a second resistor R2 which is connected between the (-) input terminal and the output terminal of the second amplifier AMP2, a third resistor R3 which is connected between the (+) input terminal of the second amplifier AMP2 and a threshold voltage TH for defining an overcurrent, and a fourth resistor R4 which is connected between the (+) input terminal of the second amplifier AMP2 and a ground voltage GND.

The second amplifier AMP2 may output a result obtained by sensing an overcurrent. The first resistor R1 and the third resistor R3 may be several KΩ and may be equal to each other. The second resistor R2 and the fourth resistor R4 may be several MΩ and may be equal to each other.

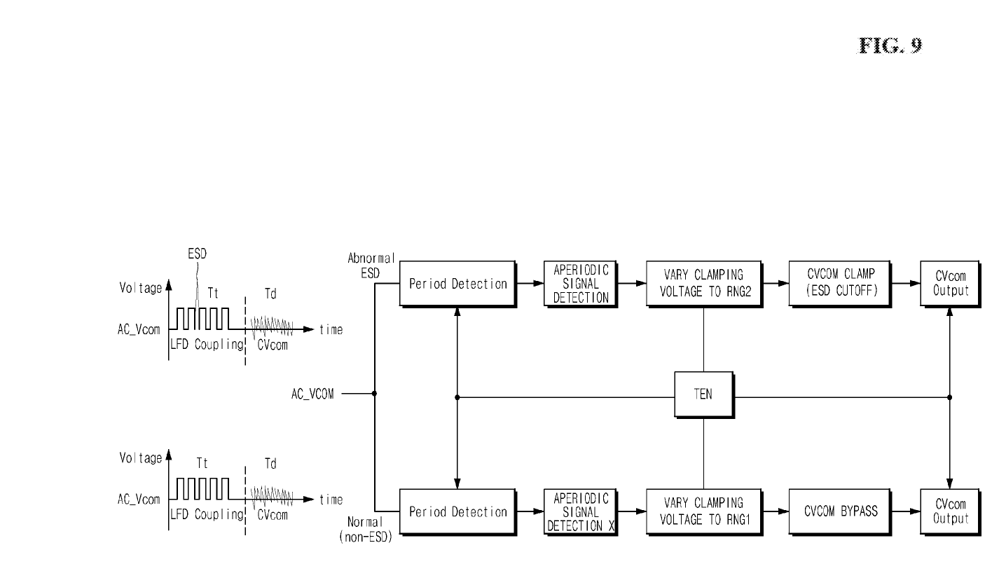

FIG. 9 is a diagram illustrating whether aperiodic ESD of a touch driving signal is detected during a touch driving period and a subsequent execution operation.

Referring to FIG. 9, an ESD protection circuit according to an embodiment of the present disclosure may sense a period of a touch driving signal LFD of an AC common signal AC_VCOM during a touch driving period Tt.

When abnormal ESD is included in the touch driving signal LFD, the ESD protection circuit may detect an aperiodic signal and may vary a difference between a positive clamping voltage PCV and a negative clamping voltage NCV to a second voltage range RNG2, based on a result of the detection, and thus, may allow a clamp circuit to clamp a portion of the AC common signal AC_VCOM. As a result, a common voltage compensation signal CVcom clamped by the clamp circuit may be output.

On the other hand, when abnormal ESD is not included in the touch driving signal LFD, the ESD protection circuit may not detect an aperiodic signal and may vary the difference between the positive clamping voltage PCV and the negative clamping voltage NCV to a first voltage range RNG1, based on a non-detection result, and thus, may allow the AC common signal AC_VCOM to be bypassed without being clamped in the clamp circuit. As a result, a common voltage compensation signal CVcom which is not clamped by the clamp circuit may be output.

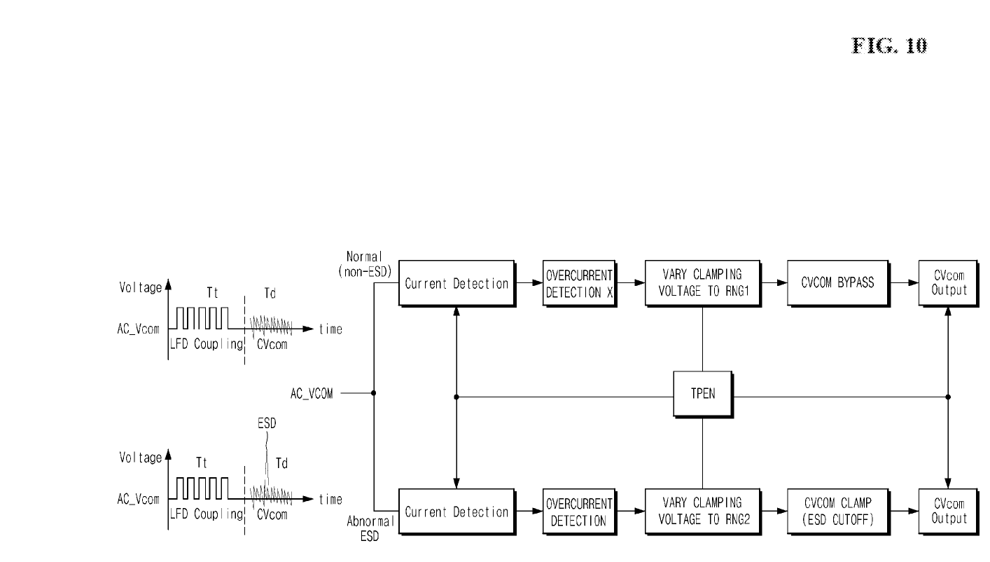

FIG. 10 is a diagram illustrating whether overcurrent ESD of a compensation common voltage is detected during a display driving period and a subsequent execution operation.

Referring to FIG. 10, an ESD protection circuit according to an embodiment of the present disclosure may sense an overcurrent of a common voltage compensation signal CVcom of an AC common signal AC_VCOM during a display driving period Td.

When abnormal ESD is included in a touch driving signal LFD, the ESD protection circuit may detect an overcurrent and may vary a difference between a positive clamping voltage PCV and a negative clamping voltage NCV to a second voltage range RNG2, based on a result of the detection, and thus, may allow a clamp circuit to clamp a portion of the AC common signal AC_VCOM. As a result, a common voltage compensation signal CVcom clamped by the clamp circuit may be output.

On the other hand, when abnormal ESD is not included in the touch driving signal LFD, the ESD protection circuit may not detect an overcurrent and may vary the difference between the positive clamping voltage PCV and the negative clamping voltage NCV to a first voltage range RNG1, based on a non-detection result, and thus, may allow the AC common signal AC_VCOM to be bypassed without being clamped in the clamp circuit. As a result, a common voltage compensation signal CVcom which is not clamped by the clamp circuit may be output.

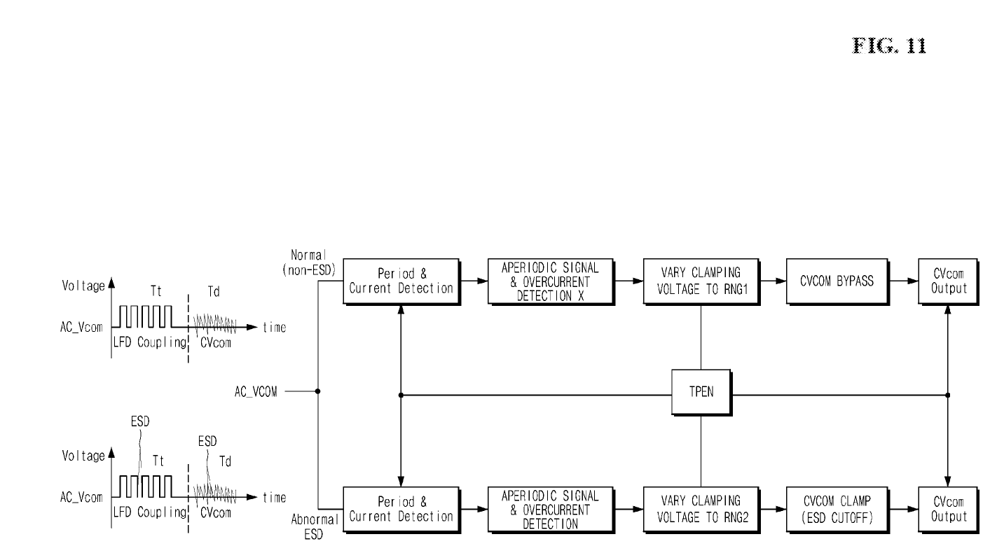

FIG. 11 is a diagram illustrating an example where cases of FIGS. 9 and 10 are combined.

Referring to FIG. 11, an ESD protection circuit according to an embodiment of the present disclosure may sense a period of a touch driving signal LFD of an AC common signal AC_VCOM during a touch driving period Tt and may sense an overcurrent of a common voltage compensation signal CVcom of the AC common signal AC_VCOM during a display driving period Td.

When abnormal ESD is included in the touch driving signal LFD, the ESD protection circuit may detect an aperiodic signal and an overcurrent and may vary a difference between a positive clamping voltage PCV and a negative clamping voltage NCV to a second voltage range RNG2, based on a result of the detection, and thus, may allow a clamp circuit to clamp a portion of the AC common signal AC_VCOM. As a result, a common voltage compensation signal CVcom clamped by the clamp circuit may be output.

On the other hand, when abnormal ESD is not included in the touch driving signal LFD, the ESD protection circuit may not detect an aperiodic signal and an overcurrent and may vary the difference between the positive clamping voltage PCV and the negative clamping voltage NCV to a first voltage range RNG1, based on a non-detection result, and thus, may allow the AC common signal AC_VCOM to be bypassed without being clamped in the clamp circuit. As a result, a common voltage compensation signal CVcom which is not clamped by the clamp circuit may be output.

The present disclosure may realize the following effects.

The touch sensing display apparatus according to the embodiments of the present disclosure may differently vary a clamping voltage, based on whether ESD is detected, and may prevent a common voltage compensation signal from being unconditionally clamped regardless of an ESD input. As a result, a compensation effect on a common voltage ripple may be maximized, and thus, display quality may be enhanced.

The effects according to the present disclosure are not limited to the above examples, and other various effects may be included in the specification.

The description herein has been presented to enable any person skilled in the art to make, use and practice the technical features of the present disclosure, and has been provided in the context of one or more particular example applications and their example requirements. Various modifications, additions and substitutions to the described embodiments will be readily apparent to those skilled in the art, and the principles described herein may be applied to other embodiments and applications without departing from the scope of the present disclosure. The description herein and the accompanying drawings provide non-limiting examples of the technical features of the present disclosure for illustrative purposes. In other words, the disclosed embodiments illustrate the scope of the technical features of the present disclosure and are not intended to be limiting in any respect. Thus, the scope of the present disclosure is not limited to the embodiments shown, but is to be accorded the widest scope consistent with the claims and their equivalents.

What is claimed is:

1. A touch sensing display apparatus, comprising:
a clamp circuit including a first diode connected between an input pad and a first voltage terminal for receiving a positive clamping voltage and a second diode connected between the input pad and a second voltage terminal for receiving a negative clamping voltage;
an electrostatic discharge (ESD) detection circuit connected between a cathode electrode of the first diode and the first voltage terminal and between a cathode electrode of the second diode and the input pad to detect whether ESD is included in an alternating current (AC) common signal input through the input pad; and
a clamp voltage variation circuit configured to, when the ESD is not detected, vary a difference between the positive clamping voltage and the negative clamping voltage to a first voltage range so that the AC common signal is not clamped in the clamp circuit, and when the ESD is detected, vary the difference between the positive clamping voltage and the negative clamping voltage to a second voltage range which is narrower than the first voltage range, so that a portion of the AC common signal is clamped in the clamp circuit.

2. The touch sensing display apparatus of claim 1, wherein a positive clamping voltage defining the first voltage range is higher than a positive clamping voltage defining the second voltage range, and
a negative clamping voltage defining the first voltage range is lower than a negative clamping voltage defining the second voltage range.

3. The touch sensing display apparatus of claim 1, further comprising a common voltage compensation circuit configured to receive a feedback common voltage from a display panel, generate a common voltage compensation signal for compensating for a ripple of the feedback common voltage, and output the AC common signal where a touch driving signal and the common voltage compensation signal are combined,
wherein one frame comprises at least one touch driving period and at least one display driving period,
the touch driving signal of the AC common signal corresponds to the touch driving period, and
the common voltage compensation signal of the AC common signal corresponds to the display driving period.

4. The touch sensing display apparatus of claim 3, wherein a touch & display drive integrated circuit is provided between the common voltage compensation circuit and the display panel, and
the clamp circuit and the ESD detection circuit are embedded in the touch & display drive integrated circuit.

5. The touch sensing display apparatus of claim 3, wherein the ESD detection circuit comprises:
a first detector configured to detect aperiodic ESD of the touch driving signal during the touch driving period; and
a second detector configured to detect overcurrent ESD of the common voltage compensation signal during the display driving period.

6. The touch sensing display apparatus of claim 5, wherein the first detector comprises:
a first amplifier including a (-) input terminal for receiving the touch driving signal of the AC common signal in the touch driving period, a (+) input terminal for receiving a reference voltage, and an output terminal; and
a counter-type comparator configured to detect aperiodic ESD of the touch driving signal when a count value of an output of the first amplifier differs from a prestored reference count value.

7. The touch sensing display apparatus of claim 5, wherein the second detector comprises:
a second amplifier including a (-) input terminal, a (+) input terminal, and an output terminal;
a first resistor connected between the (-) input terminal of the second amplifier and an input of the AC common signal;
a second resistor connected between the (-) input terminal and the output terminal of the second amplifier;
a third resistor connected between the (+) input terminal of the second amplifier and a terminal providing a threshold voltage for defining an overcurrent; and
a fourth resistor connected between the (+) input terminal of the second amplifier and a terminal providing a ground voltage.

8. A clamping voltage control method of a touch sensing display apparatus including a clamp circuit including a first diode connected between an input pad and a first voltage terminal receiving a positive clamping voltage and a second diode connected between the input pad and a second voltage terminal receiving a negative clamping voltage, the clamping voltage control method comprising:
detecting whether electrostatic discharge (ESD) is included in an alternating current (AC) common signal input through the input pad, in an ESD detection circuit connected between a cathode electrode of the first diode and the first voltage terminal and between a cathode electrode of the second diode and the input pad; and
when the ESD is not detected, varying a difference between the positive clamping voltage and the negative clamping voltage to a first voltage range so that the AC common signal is not clamped in the clamp circuit, and when the ESD is detected, varying the difference between the positive clamping voltage and the negative clamping voltage to a second voltage range which is narrower than the first voltage range, so that a portion of the AC common signal is clamped in the clamp circuit.

9. The clamping voltage control method of claim 8, wherein a positive clamping voltage defining the first voltage range is higher than a positive clamping voltage defining the second voltage range, and
a negative clamping voltage defining the first voltage range is lower than a negative clamping voltage defining the second voltage range.

10. The clamping voltage control method of claim 8, further comprising: receiving a feedback common voltage from a display panel, generating a common voltage compensation signal for compensating for a ripple of the feedback common voltage, and outputting the AC common signal where a touch driving signal and the common voltage compensation signal are combined,
wherein one frame comprises at least one touch driving period and at least one display driving period,
the touch driving signal of the AC common signal corresponds to the touch driving period, and
the common voltage compensation signal of the AC common signal corresponds to the display driving period.
